(19) United States
(12) Patent Application Publication
(10) Pub. No.: US 2025/0346749 A1
(43) Pub. Date: Nov. 13, 2025

(54) SEALANTS FOR HIGH PRESSURE HYDROGEN GAS STORAGE AND TRANSPORTATION

(71) Applicant: BATTELLE MEMORIAL INSTITUTE, Richland, WA (US)

(72) Inventor: Samy A. Madbouly, Richland, WA (US)

(73) Assignee: BATTELLE MEMORIAL INSTITUTE, Richland, WA (US)

(21) Appl. No.: 19/201,353

(22) Filed: May 7, 2025

Related U.S. Application Data
(60) Provisional application No. 63/643,811, filed on May 7, 2024.

(51) Int. Cl. C08L 23/16; C09K 3/10

(52) U.S. Cl. CPC C08L 23/16; C09K 3/10; C08L 2205/025; C08L 2205/035; C08L 2312/00; C09K 2200/0476; C09K 2200/0607; C09K 2200/0637

(57) ABSTRACT

Embodiments provide rubber sealants and rubber sealant formulations for use in high pressure hydrogen storage and transportation. Example sealant formulations include mixtures of ethylene propylene diene monomers (EPDMs) or EPDM-like materials, optional thermally conductive fillers, optional hydrogen barrier fillers, reinforcing fillers, liquid rubbers, antioxidants, optional abrasion resistance additives, and curing agents (e.g., cross-linking agents). Example formulations are capable of peroxide curing to produce thermosetting elastomers with excellent thermomechanical properties. Example sealants provide very low equilibrium hydrogen concentrations and reduced swelling.

### RELATED APPLICATIONS

This application claims benefit of U.S. Patent Application No. 63/643,811 filed May 7, 2024. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to field of high pressure hydrogen gas storage and transportation, and more particularly to sealants and sealant materials for use in such applications, and even more particularly to rubber sealants and thermosetting sealants.

### Background Information

Hydrogen gas is one of the most important sources of clean energy. Hydrogen gas can be compressed, stored, and transported under high pressure of 70 to 90 Megapascals (MP) as a highly efficient green fuel. Hydrogen gas has been used in different applications such as, for example, in petroleum and metal refining, in synthetic ammonia production, and as a fuel for fuel cell vehicles. A wide range of commercially available thermoplastics (e.g., polyethylene (PE), polypropylene (PP), polyamide (PA), and the like) as well thermosetting rubbers (such as, for example, EPDM, nitrile butadiene rubber (NBR), hydrogenated nitrile butadiene rubber (HNBR), fluoroelastomer (FKM), and the like) are commonly used in hydrogen gas storage vessels and tanks mainly as liners, pipes, and sealants. Carbon fiber reinforced epoxy composites have also been extensively used as part of hydrogen storage vessels. Due to the very small size and the extremely high diffusivity of the hydrogen molecule, most of these thermoplastics and rubber sealant materials are eventually degraded under high hydrogen pressure which might result in leaks and even sudden unavoidable catastrophic failure. For example, sealants can significantly swell due to the diffusion of hydrogen under high pressure. The mechanical properties, such as modulus and tensile strength will be considerably decreased by the diffused hydrogen. High decompression rate of hydrogen gas from high pressure to low pressure is also another problem that commonly induces blisters or cracks, as well as permanent physical damage in the sealants.

Therefore, a need remains for improved thermally, mechanically, and morphologically stable materials that can be used in different critical applications in hydrogen gas storage and transportation infrastructure. Furthermore, sealant materials are required for flow control components such as dispensing hoses, flange connections, and valves as well as other hydrogen storage components and devices where the components are subject to not only high pressure and rapid pressure changes but also subject to large temperature variations from, for example, −40 to 90° C.

A need also exists for formulations having lower equilibrium hydrogen concentrations and lower swelling percentages under high hydrogen pressure and/or rapid release of pressure. Furthermore, a need exists for sealants with improved or tailorable properties, such as mechanical properties, glass transition temperatures (Tg), coefficients of thermal expansion (CTE), thermal stability, and dielectric properties. Worded another way, improved sealants are needed that provide required properties that won't be degraded (physically or chemically) within a reasonable anticipated product lifetime when subjected to extreme conditions or rapid variations in such conditions.

### SUMMARY

To address one or more of the above needs, some embodiments of the invention provide EPDM based sealant materials with high stability under high hydrogen gas pressure, e.g. of 70 to 90 MPa (Megapascals), with insignificant physical or chemical degradations (e.g., not more than 1.1° C. decrease in T_{g} and not more than 0.1 g/cm³ change in density) resulting from rapid decompression (e.g. at a pressure loss rate of 15 MPa/minute) when dropping from a high hydrogen gas pressure to ambient pressure wherein the high pressure was held for 24 hours or until equilibrium concentration was obtained.

To address one or more of the above needs, some embodiments of the invention provide EPDM based and EPDM-like sealant material mixtures (i.e., mixtures of Type A, B, and C materials discussed hereafter) demonstrating very low equilibrium hydrogen concentrations (e.g., from about 2.3-3.0 wt. ppm/mm³ compared to 6.3 to 7.4 wt. ppm/mm³ for other formulations) when under high hydrogen pressure and relatively low hydrogen swelling (i.e., no more than 50%, preferably no more than 45%, more preferably no more than 42% and most preferably no more than 39%). Specific embodiments illustrated herein show swelling as a result of rapid decompression (e.g., at 15 MPa/minute) that range from about 37%-41% instead of 80%-250% for tested exemplary prior art formulations.

To address one or more of the above needs, some embodiments of the invention provide rubber sealant formulations that include: (1) an ethylene propylene diene monomer (EPDM) mixture, (2) an optional thermally conductive filler (e.g., boron nitride), (3) a hydrogen barrier filler (e.g., PTFE, surface treated silica, or a combination thereof), (4) one or more reinforcing fillers (e.g., carbon black or surface treated silica), (5) liquid rubber (e.g., polybutadiene), (6) at least one antioxidant additive such as, for example, zinc 2-mercaptotolumidazole (e.g., VANOX ZMTI and/or VANOX CDPA), (7) an optional abrasion resistant additive (e.g., PTFE which may also function as an hydrogen barrier), (8) a heat stabilizer (e.g., red lead oxide or red lead tetra oxide, Pb₃O₄, e.g. ERD-90 from Metals and Additives LLC of Brazil, Indiana); (9) a good light and weather resistant filler (e.g., iron oxide or ferric oxide), (10) a processing and property improvement (physical, mechanical, and thermal) additive for EPDM such as, for example, zinc oxide.

In some embodiments of the invention, formulations include peroxide for curing (i.e., for forming a cross-linked, thermoset structure), to produce thermosetting elastomers with excellent thermomechanical properties. An example peroxide includes LUPEROX from Arkema. Excellent thermomechanical properties include, for example, (1) a stable glass transition temperature (Tg), stable storage modulus before and after exposure of the sealant to 90 MPa hydrogen for 24 hours, and low equilibrium hydrogen concentration in the sealant at 90 MPa hydrogen, wherein stable Tg refers to Tg changing by no more than 3.0° C. and more preferably no more than 1.5° C. and most preferably no more than 1.1° C.; stable modulus refers to a storage modulus changing by no more than 35%, and more preferably no more than 20% and most preferably no more than 16%; while low equilibrium hydrogen concentration refers to no more than 5 wt ppm/mm³, more preferably no more than 4 wt ppm/mm³, and most preferably no more than 3 wt ppm/mm³ resulting from a 24 hour, 90 MPa hydrogen exposure. Some embodiments provide high thermal conductivity (e.g., in some cases at least 0.5 W m⁻¹ k⁻¹, in some other cases at least 1.0 W·m⁻¹·K⁻¹, in still other cases at least 1.5 W·m⁻¹·K⁻¹, and in still further cases at least 1.7 W·m⁻¹·K⁻¹). In some cases thermal conductivity is enhanced by inclusion of thermally conductive fillers such as boron nitride. Other embodiments may alternatively include sulfur or some other curing agent instead of peroxide.

Without being held to a specific theory of functionality, it is believed that the unique behavior the formulations of various embodiments of the invention is attributed to a combination of special types and quantities of the different fillers and additives, that provide reinforcement, thermal conductivity, abrasion resistant, antioxidants, and plasticizers. In some embodiments, components providing each of these characteristics are provided while in other embodiments, only a portion of these characteristic enhancing components may be used.

In a first aspect of the invention, a sealant for high pressure hydrogen gas storage, includes: (a) 40 to 60 wt % elastomer as a combination of an ethylene propylene diene monomer (EPDM) mixture and polybutadiene wherein the EPDM mixture, includes: (I) a first EPDM component (EPDM-A) including an EPDM material having a vinyl norbornene diene content in the range of 1%-7% of the first EPDM component and a high ethylene/propylene weight ratio in the range of 60:40 to 51:49 which forms a crystalline terpolymer having a Mooney viscosity in a range of 30 to 60 Mooney units, and a specific gravity in the range of 0.8 to 1.1 g/cm³; (II) a second EPDM-like component (EPDM-B) including an ethylene-propylene liquid copolymer having an ethylene/propylene ratio in the range of 35:65 to 47:53, a density in the range of 0.8-1.1 g/cm³, a molecular weight in the range of 15,000 to 60,000 g/mol, and a viscosity at 100° C. in the range of 30,000 to 155,000 cP wherein the second EPDM component provides an intermediate quantity of the EPDM mixture which is less than the portion of the EPDM mixture provided by the first EPDM component; and (III) a third EPDM component (EPDM-C) including a low-molecular weight EPDM terpolymer having a diene content in the range of 5% to 12 wt % of the third EPDM component, and an ethylene/propylene ratio in the range of 40:60 to 53:47, a density in the range of 0.8-1.1 g/cm³, a molecular weight in the range of 30,000 to 100,000 g/mol, and a viscosity at 100° C. in the range of 100,000 to 210,000 cP, wherein the third EPDM component provides the smaller quantity of the EPDM mixture than either the first component or the second component; (b) an ultrafine particle reinforcement material providing 0 to 40wt % of the sealant exclusive of any BN or PTFE wherein the ultrafine material is selected from the group consisting of (I) carbon black, (II) a silica-based material; and (III) a combination of (b)(I) and (b)(II); (c) 0.5 to 3.0 wt % zinc 2-mercaptotolumidazole; (d) 0.1 to 3.0 wt % iron oxide (Fe₂O₃); (e) 0 to 5 wt % zinc oxide (ZnO); (f) 1.0-3.0 wt % red lead tetra oxide; (g) 0-30 phr powdered polytetrafluoroethylene (PTFE); (h) 0-30 phr powdered boron nitride (BN); and (i) 1.5-3.5 wt % of a curing agent including a material selected from the group consisting of: (I) peroxide, (II) sulfur; (III) a combination of (i)(I) and (i)(II); wherein the weight percentages of components of (a) to (f) are based on the total of the weight of components (a) to (f) unless otherwise specifically indicated, the phr of components (g) and (h) are based on total weight of components (a) to (f), and the weight percentage of the curing agent is based on the total weight of components (a)-(h), and wherein the sealant includes components (a)-(i) cured together.

Numerous variations of the first aspect of the invention exist and include, for example: (1) the first EPDM component providing 50 to 75 wt % of the EPDM mixture; the second EPDM component providing 10 to 30 wt % of the EPDM mixture; and the third EPDM component providing 5 to 20 wt % of the EP MD mixture; (2) the first variation of the first aspect wherein the first EPDM component provides 70-71 wt % of the EPDM mixture; the second EPDM component provides 20-21 wt % of the EPDM mixture; and the third EPDM component provides 8-10 wt % of the EPDM mixture; (3) the first or second variations of the first aspect or the first aspect itself wherein the EPDM mixture provides 80 to 95 wt % of the elastomer; (4) the first aspect or the first or second variations thereof wherein the polybutadiene provides 5 to 20 wt % of the elastomer components; (5) the fourth variation of the first aspect wherein the polybutadiene provides 6-8 wt % of the elastomer components; (6) the first aspect or any of the first to fifth variations thereof wherein the ultrafine particle reinforcement material includes a combination of (b)(I) and (b)(II) of the first aspect; (7) wherein the formulation comprises (b)(II) and wherein the silica-based mineral of (b)(II) is selected from the group consisting of: (A) an aluminosilicate material, and (B) a surface treated silica; (8) the sixth or seventh variation of the first aspect wherein the silica-based material includes up to 39.9 wt % of the sealant; (9) the first aspect or any of the first to eighth variations thereof wherein the carbon black provides 0.1 to 30 wt % of the sealant; and (10) the first aspect or any of the first to ninth variations thereof wherein the iron oxide provides 0.1-2.0 wt % of the sealant.

Additional variations of the first aspect of the invention include, for example: (11) the first aspect or any of the first to tenth variations thereof wherein the zinc oxide provides 1-5 wt % of the sealant; (12) the first aspect or any of the first to eleventh variations thereof wherein the curing agent includes a cross-linking agent; (13) the twelfth variation of the first aspect wherein the cross-linking agent includes peroxide; (14) the first aspect or any of the first to thirteenth variations thereof wherein the sealant includes PTFE but not boron nitride; (15) the fourteenth variation of the first aspect wherein the sealant includes 4 to 15 phr PTFE; (16) the fourteenth variation of the first aspect wherein the sealant includes 8 to 12 phr PTFE; (17) the first aspect or any of the first to thirteenth variations thereof wherein the sealant includes boron nitride but not PTFE; (18) the seventeenth variation of the first aspect wherein sealant includes 4 to 15 phr of boron nitride; (19) the eighteenth variation of the first aspect wherein the sealant includes 8-12 phr boron nitride; and (20) the first aspect or any of the first to thirteenth variations thereof wherein the sealant includes both PTFE and boron nitride.

Still further variations of the first aspect of the invention include, for example: (21) the first aspect or any of the first to twentieth variations thereof wherein the sealant possesses an equilibrium hydrogen concentration of less than 4.0 wt. ppm/mm³; (22) the twenty-first variation of the first aspect wherein the sealant possesses an equilibrium hydrogen concentration of less than 3.0 wt. ppm/mm³; (23) the twenty-second variation of the first aspect wherein the sealant possesses an equilibrium hydrogen concentration of less than 2.5 wt. ppm/mm³; (24) the first aspect or any of the first to twenty-third variations thereof wherein the sealant swells less than 200% when subjected to a pressure reduction from 90 MPa to 1 ATM in 6 minutes or less; (25) the twenty-fourth variation of the first aspect wherein the sealant swells less than 100% when subjected to a pressure reduction from 90 MPa to 1 ATM in 6 minutes or less; and (26) the twenty-fourth variation of the first aspect wherein the sealant swells less than 50% when subjected to a pressure reduction from 90 MPa to 1 ATM in 6 minutes or less.

In a second aspect of the invention a sealant formulation useful for high pressure hydrogen gas storage applications when cured, includes: (a) 40 to 60 wt % elastomer as a combination of an ethylene propylene diene monomer (EPDM) mixture and polybutadiene wherein the EPDM mixture, includes: (I) a first EPDM component (EPDM-A) including an EPDM material having a vinyl norbornene diene content in the range of 1%-7 wt % of the first EPDM component and a high ethylene/propylene weight ratio in the range of 60:40 to 51:49 which forms a crystalline terpolymer having a Mooney viscosity within a range of 30 to 60 Mooney units, and a specific gravity within the range of 0.8 to 1.1 g/cm3; (II) a second EPDM-like component in the form of an ethylene-propylene liquid copolymer having an ethylene/propylene ratio in the range of 35:65 to 47:53, a density in the range of 0.8-1.1 g/cm³, a molecular in the range of 15,000 to 60,000 g/mol, and a viscosity at 100° C. within the range of 30,000 to 155,000 cP wherein the second EPDM component provides an intermediate quantity of the EPDM mixture which is less than the portion of the EPDM mixture provided by the first EPDM component; and (III) a third EPDM component including a low-molecular weight EPDM terpolymer having a diene content in the range of 5% to 12 wt % of the third EPDM component, and an ethylene/propylene ratio in the range of 40:60 to 53:47, a density in the range of 0.8-1.1 g/cm³, a molecular weight in the range of 30,000 to 100,000 g/mol, and a viscosity at 100° C. within the range of 100,000 to 210,000 cP, wherein the third EPDM component provides the smaller quantity of the EPDM mixture than either the first component or the second component; (b) an ultrafine particle reinforcement material providing 0 to 40 wt % of the sealant exclusive of any BN or PTFE wherein the ultrafine material includes a material selected from the group consisting of (I) carbon black, (II) a silica-based material; and (III) a combination of (b)(I) and (b)(II); (c) 0.5 to 3.0 wt % zinc 2-mercaptotolumidazole; (d) 0.1 to 3.0 wt % iron oxide (Fe₂O₃); (e) 0 to 5 wt % zinc oxide (ZnO); (f) 1.0-3.0 wt % red lead tetra oxide; (g) 0-30 phr powder polytetrafluoroethylene (PTFE); (h) 0-30 phr powdered boron nitride (BN); and wherein the weight percentages of components of (a) to (f) are based on the total weight of components (a) to (f) unless otherwise specifically indicated, and the phr of components (g) and (h) are also based on total weight of components (a) to (f), and wherein the components are curable to form a sealant material.

Numerous variations of the second aspect of the invention exist and include, for example variations similar to those noted for the first aspect, mutatis mutandis.

In a third aspect of the invention a sealant formulation useful for high pressure hydrogen gas storage applications, includes: (a) 40-60 wt % of an elastomer mixture including two different EPDM terpolymer materials having different diene contents and different ethylene/propylene ratios, an ethylene/propylene copolymer, and a polybutadiene material; (b) 0 to 40 wt % of an ultrafine particle reinforcement material that includes a silica-based material; (c) 0.5 to 3.0 wt % zinc 2-mercaptotolumidazole; (d) 0.1 to 3.0 wt % iron oxide (Fe₂O₃); (e) 0 to 5 wt % zinc oxide (ZnO); (f) 1.0-3.0 wt % red lead tetra oxide; (g) 0-30 phr powder polytetrafluoroethylene (PTFE); and (h) 0-30 phr powdered boron nitride (BN); wherein the weight percentages of components of (a) to (f) are based on the total of the weight of components (a) to (f) and the phr of components (g) and (h) are also based on total weight of components (a) to (f), and wherein the components are curable to form a material capable of being used as a hydrogen sealant.

Numerous variations of the third aspect of the invention exist and include, for example variations similar to those noted for the first aspect, mutatis mutandis.

Other objects and advantages of various aspects and embodiments of the invention will be apparent to those of skill in the art upon review of the teachings herein. The various aspects and embodiments of the invention, set forth specifically herein or otherwise ascertained from the teachings herein, may address any one of the above objects alone or in combination, or alternatively may address some other object of the invention ascertained from the teachings herein. It is not intended that any specific aspect or embodiment of the invention necessarily address any of the objects set forth above let alone address all these objects simultaneously; however, some aspects and embodiments may address a plurality of these objects simultaneously.

### BRIEF DESCRIPTION OF THE DRAWINGS

The patent or application file contains at least one drawing executed in color. Copies of this patent or patent application publication with color drawing(s) will be provided by the Office upon request and payment of any necessary fee.

FIG. 1 provides a table setting forth component listings and quantities for five example formulations (Ex 1 to Ex 5) in weight percentage units (wt %) for EPDM+ components (i.e. all of the components of Sealant Ex 1 with the exception of the peroxide curing agent) and parts per hundred (phr) for the PTFE and BN components added to Ex 2-Ex 5 wherein the phr amounts are based on the total weight of EPDM+ components with the exception of the peroxide curing agent, and wherein the wt % of the peroxide curing agent is based on the total weight of all components in the particular example (Ex 1 to Ex 5).

FIGS. 2A-2C respectively provide modulus data, tensile strength data and elongation data for each of the five sealants of FIG. 1.

FIG. 3A provides a plot of pressure (in MPa) versus time (in hours) showing a high pressure applied for 24 hours for three comparison samples EPDM-1 to EPDM-3 and for three of the sealants of FIG. 1 followed by a rapid pressure drop off at 24 hours while FIG. 3B provides a plot of current sample volume (V) relative to an initial or pressured sample volume (V₀) for each sample with a large plot showing the full time period and with an inlaid plot showing a time range from 23 to 27 hours so that variations over time associated with the pressure transition can be more readily seen.

FIG. 4 provides a bar chart showing swelling amounts for comparison samples EPDM-1 to EPDM-3 and for a single example sealant formed from EX 4 (EPDM+& 5% BN) of the sealant formulations of FIG. 1 which showed a significant reduction in swelling relative to the comparison samples (as did the sealants formed from the other examples of FIG. 1).

FIGS. 5A-5E provided thermal desorption analysis data for the sealants of FIG. 1 along with results of fitting the data to Fick's gas diffusion equation which yielded values for C₀ and D.

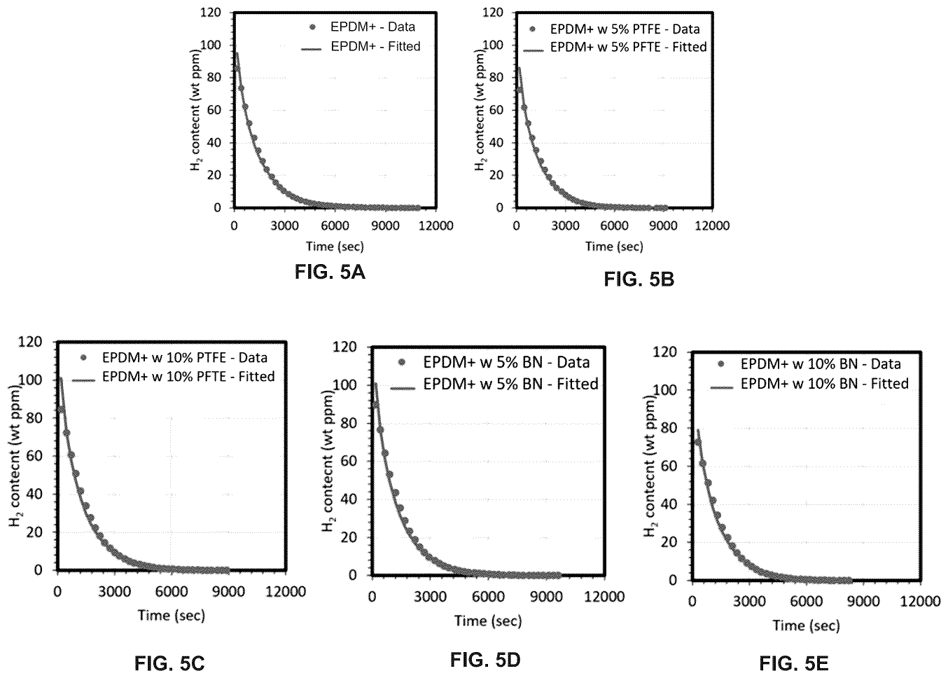

FIG. 6A provides equilibrium hydrogen concentration data, swelling % data, and diffusion coefficient data for each of the five sealants of FIG. 1 as well as for the comparison sealants EPDM-1 to EPDM-3 while FIG. 6B provides bar graphs of Co for a representative member (Ex. 4) of the sealants of FIG. 1 and for each of the comparison sealants.

FIGS. 7A-7E provide, ATR-FTIR plots before and after hydrogen pressurization for each of the sealants of FIG. 1.

FIGS. 8A and 8B respectively provide density bar charts and data for the sealants of FIG. 1 before and after high pressure hydrogen treatment.

FIGS. 9A provides plots of dynamic viscosity as a function of angular frequency for Sealant Ex 1, Sealant Ex 2, and Sealant Ex 4 at 45° C. while FIG. 9B provides similar plots for Sealant Ex 1, Sealant Ex 3, and Sealant Ex 5 also at 45° C.

FIG. 10 provides a table of characteristic rheological parameters, hardness, and crosslink density for each of the cured example EPDM formulations EPDM Ex 1 to Ex 5 wherein the heading of each column shows the relevant parameter and the associated units.

FIG. 11A provides plots of (a) Dynamic elastic (G′) and viscous (G″) moduli as a function of angular frequency for Sealant Ex 1, Sealant Ex 2, and Sealant Ex 4 at 45° C. while FIG. 11B provides similar plots for Sealant Ex 1, Sealant Ex 3, and Sealant Ex 5 also at 45° C.

FIG. 12 provides bar charts of compression set before and after static hydrogen exposure wherein average and standard deviation values for a pre-hydrogen exposure sample and a separate post-hydrogen exposure sample for each of the sealant examples Ex 1 to Ex 5 are provided.

FIG. 13 provides plots of storage modulus at 25° C. (upward directed bars) and glass transition temperatures (tan delta peak) for sealants Ex 1 to Ex 5 showing average and standard deviations for multiple measurements on single separate samples used to provide each individual bar plot wherein “before stor mod” and “before Tg” shows the data for samples measured prior to high hydrogen exposure and wherein “static ambient stor mod” and static ambient Tg show data for samples measured after high pressure hydrogen exposure at 90 MPa for 24 hours.

### DETAILED DESCRIPTION OF THE INVENTION

Various advantages and novel features of the present invention are described herein and will become even more apparent to those skilled in this art from this detailed description. In the preceding and following descriptions several embodiments of the invention are set forth which include an illustration of the best mode contemplated for carrying out the invention. As will be apparent to those of skill in the art after review of the teachings herein, embodiments of the invention are capable of modification in various respects without departing from the spirit of invention. Accordingly, the drawings and description of the embodiments set forth hereafter are to be regarded as illustrative in nature, and not as restrictive.

### Overview of Terms

The following explanations of terms and abbreviations are provided to better describe the present disclosure and to guide those of ordinary skill in the art in the practice of the teachings set forth herein. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice of embodiments, aspects, claims, or variations thereof suitable methods and materials are described below. The materials, methods, and examples are illustrative only and are not intended to be limiting. Other features of the disclosure will be apparent to those of skill in the art from the previous teachings and from following detailed description and the claims.

Unless otherwise indicated, all numbers expressing quantities of components, molecular weights, molarities, weight percents, parts per hundred rubber, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects of the disclosure from discussed prior art, the numbers are not approximates unless the word “about” is recited.

Although the operations of some of the aspects of the disclosure are described in a particular, sequential order, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide”, “mix”, “cure”, “cross-link”, and the like to describe the disclosed methods. These terms are high-level abstractions of the actual operations that are performed. The actual operations that correspond to these terms may vary depending on the particular implementation and are readily discernible by one of ordinary skill in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

### EXAMPLES

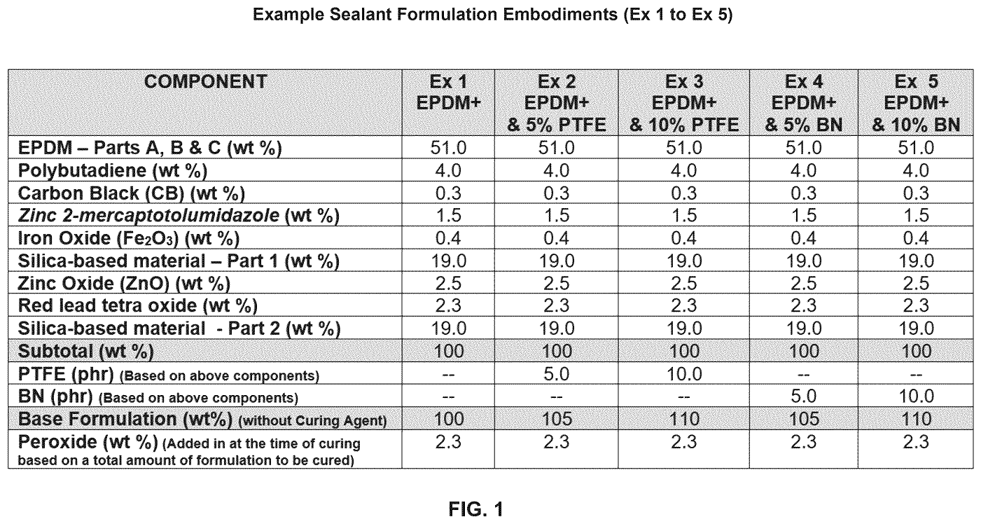

Embodiments of the invention provide rubber sealant formulations made of ethylene propylene diene monomers (EPDMs), optional thermally conductive fillers, hydrogen barrier fillers, and reinforcing fillers, as well as liquid rubber, antioxidant, and optional abrasion resistant additives. The formulations are capable of peroxide or other curing to produce thermosetting elastomers with excellent thermomechanical properties (e.g., no more than a 1.1° C. decrease in T_{g}, less than 0.1 g/cm³ decrease in density, and no more than a 20% decrease in storage modulus), very low equilibrium hydrogen concentrations at 90 MPa (i.e., no more than 3.0 wt ppm/mm³, e.g., as low as 2.2 wt ppm/mm³), and in some embodiments a high thermal conductivity (e.g., at least 0.5 W m⁻¹·K⁻¹, in some cases at least 1.0 W·m⁻¹·K⁻¹, in some cases at least 1.5 W·m⁻¹·K⁻¹, and in still other cases at least 1.7 W·m⁻¹·K⁻¹). In various tests performed, no chemical or mechanical failures were observed under high hydrogen gas pressure up to 90 MPa or during the rapid decompression processes. The densities and the chemical structures as evaluated using FTIR showed no significant changes before and after the thermal desorption analysis (TDA). In addition, in-situ swelling during rapid decompression at a rate of 15 MPa/min from high hydrogen pressure of 90 MPa was approximately 39±2% for the sealants of FIG. 1 compared to 80% to 250% for the EPDM-1 to EPDM-3 prior art sealants. The formulations for all embodiments have extremely low equilibrium hydrogen concentrations under high hydrogen pressure compared to the commercially available sealants currently used in hydrogen storage and transportation infrastructure (2.2-2.9 for Ex 1 to Ex 5 compared to 6 wt ppm/mm³, or more, for EPDM-1 to EPDM-3 for the tested) and low swelling % during pressure transitions.

It is believed that the described peroxide-curable elastomer formulations are suitable for demanding hydrogen applications, including high-pressure storage tanks, transportation pipelines, refueling station components, flow controllers, flow meters, fuel cell vehicle systems, stationary fuel cell systems, and the like. Their thermomechanical properties, e.g., low hydrogen permeability, high thermal conductivity, and minimal swelling during rapid decompression make them useful in seals, gaskets, o-rings, valve seats, diaphragms, valve components, and compressor systems operating under pressures up to 90 MPa. Unlike conventional EPDM materials, these formulations maintain structural integrity, resist chemical and mechanical failure, and ensure long-term durability (e.g. perhaps up to 10 years or more) and safety across hydrogen storage, flow control, and transport infrastructure.

FIG. 1 provides a table setting for component listings and quantities in weight percentage units (except for PTFE and BN components which are set forth in part per hundred rubber (phr)) for five 5 example sealants. The curing component, e.g. peroxide in these examples, will generally be added in after all other components have been mixed when it is time to cure the mixture to produce a sealant. The relative weight percentages for each component for a given sealant may be obtained by taking the component weight and dividing it by the summed weight of all components excluding the PTFE, BN, and the curing component, wherein PTFE and BN quantities are set forth in parts per hundred rubber with the basis being the sum of the total weights of all the components identified as part of EPDM+ (i.e., Ex 1) exclusive of the weight of the curing component, and wherein the curing component quantity (i.e., weight percentage) is based on the summed weights of all other sealant components for the specific sealant including any PTFE and BN.

The first row of the table indicates that 51 weight units of an EPDM mixture is provided for each of the five example formulations. Each formulation includes 100 weight units of EPDM+ components (exclusive of the weight of the curing agent or component) with Ex 2 to Ex 5 additionally including PTFE or BN components as well. The PTFE and BN components found in Ex 2 to Ex 5 are not considered part of the 100 weight units but instead are provided as parts per hundred as an add on to the EPDM+ components.

As can be seen row 11 of the table, in the Ex 2 and Ex 3 sealant formulations, PTFE is provided as 5.0 parts per hundred rubber (phr) by weight and 10.0 phr, respectively. As can be seen in row 12 of the table, in the Ex 4 and Ex 5 sealant formulations, BN is provided as 5.0 phr and 10.0 phr, respectively.

The EPDM mixture is combination of three EPDM and EPDM-like materials. These materials are labeled as Part A or EPDM-A, Part B or EPDM-B, and Part C or EPDM-C. These components have different properties and may be provided in a variety of different relative amounts in alternative embodiments. Also in different embodiments, each of these components may be varied so long as required parameters or attributes remain within target ranges.

EPDM-A (e.g., ROYALENE-511 from Lion Elastomers) is the first EPDM component and is an EPDM material having a vinyl norbornene diene content of nominally 4.6 wt % and a ethylene/propylene weight ratio of 57:43 which forms a crystalline terpolymer having a low Mooney viscosity (i.e. a Mooney viscosity that is within the range of 41 to 51 in Mooney units at 100° C.), a specific gravity 0.86 g/cm³. In alternative embodiments, this EPDM component may vary from the parameters noted above and may have parameters that fall within a set of broader ranges to narrower ranges within different embodiment alternatives. It may for example have: (1) a vinyl norborene diene content in the range of 1-7 wt %, or more narrowly 2-6 wt %; or even more narrowly 3-5%; (2) a ethylene/propylene ratio in the range of 60:40 to 51:49, more narrowly in the range of 59:41 to 54:46, or even more narrowly in the range of 58:42 to 56:44, (3) a density or specific gravity in the range of 0.8-1.1 g/cm³, more narrowly from in the range of 0.82 to 0.98 g/cm³, or even more narrowly in the range of 0.84 to 0.92 g/cm³; (4) a molecular weight in the range of 100,000-300,000 g/mol, more narrowly in the range of 130,000 to 270,000 g/mol, or even more narrowly in the range of 160,000 to 240,000 g/mol; and (5) a Mooney viscosity of in the range of 30-60 Mooney units, more narrowly in the range of 33-57 Mooney units, or even more narrowly in the range of 36 to 53 Mooney units. EPDM-A in the examples of Table 1 provides 35.5 wt. units out of the total of 51 weight units provided by the three EPDM-A to EPDM-C components.

EPDM-B (e.g., TRILENE CP80 from Lion Elastomers) is the second EPDM component and is actually an EPDM-like component but not actually an EPDM material. It is an ethylene-propylene liquid copolymer having an ethylene/propylene weight ratio of 41:59, a viscosity of 76,000 cP 100° C., a specific gravity of 0.86 g/cm³, and a molecular weight of 23,000 g/mol (by GBC). In alternative embodiments, this EPDM component may vary from the parameters noted above and may have parameters that fall within a set of broader ranges to narrower ranges within different embodiment alternatives. It may for example have: (1) an ethylene/propylene ratio in the range of 35:65 to 47:53, more narrowly from 37:63 to 45:55, or even more narrowly from 39:41 to 43:57; (2) a density in the range of 0.8-1.1 g/cm³, more narrowly from 0.82 to 0.98 g/cm³, or even more narrowly from 0.84 to 0.92 g/cm³; (3) a molecular weight in the range of 15,000 to 60,000 g/mol, more narrowly from 18,000 to 50,000 g/mol, or even more narrowly from 20,000 to 40,000 g/mol; and (4) a viscosity at 100° C. within the range of 30,000 to 155,000 cP, more narrowly from 45,000 to 100,000 cP, or even more narrowly from 60,000 to 90,000 cP. The EPDM-B component provides 10.5 wt. units out of the 51 weight units provided by the three EPDM-A TO EPDM-C components.

EPDM-C is the third EPDM (TRILENE 67 from Lion Elastomers) component which is a low-molecular weight liquid ethylene propylene (EPDM) terpolymer having 9.5% diene content (e.g. in the form of 9.5% ethylene-propylene-ethylidene norbornene) and an ethylene/propylene ratio of 46:54, which forms terpolymer having a viscosity of 128,000 cP 100° C., a specific gravity of 0.86 g/cm³, a molecular weight of 39,000 g/mol (by GBC). In alternative embodiments, this EPDM component may vary from the parameters noted above and may have parameters that fall within a set of broader ranges to narrower ranges within different embodiment alternatives. It may for example have: (1) a diene content that ranges from 5% to 12%, more narrowly from 7% to 10%, or even more narrowly from 8% to 10%; (2) an ethylene/propylene ratio in the range of 40:60 to 53:47, more narrowly from 42:58 to 51:49, or even more narrowly from 44:56 to 48:52; (3) a density in the range of 0.8-1.1 g/cm³, more narrowly in the range of 0.82 to 0.98 g/cm³, or even more narrowly in the range of 0.84 to 0.92 g/cm³; (4) a molecular weight in the range of 30,000 to 100,000 g/mol, more narrowly in the range of 30,000 to 70,000 g/mol, or even more narrowly in the range of 30,000 to 50,000 g/mol; and (5) a viscosity at 100° C. within the range of 100,000 to 210,000 cP, more narrowly in the range of 100,000 to 150,000 cP, or even more narrowly in the range of 100,000 to 140,000 cP. The EPDM-C component provides 5 wt units out of the 51 weight units provided by the three EPDM-A TO EPDM-C components.

In other embodiments EPDM-A may range from 50-75 wt % of the total three part EPDM mixture, more narrowly from 60 to 75, or even more narrowly from 65 to 75 while EPDM-B may range from 10 to 30 wt % of the total three part EPDM mixture, more narrowly from 13 to 27, or even more narrowly from 16 to 24, and EPDM-C may range from 5 to 20 wt % of the total three part EPDM mixture, more narrowly from 6 to 16, or even more narrowly from 7 to 13. In other embodiments the total EPDM mixture may provide 40-60 wt % of the formulation, more narrowly from 43 to 57 wt %, or even more narrowly from 47 to 55 wt %.

Polybutadiene is provided as an additional component of the sealants and is more particularly an additional part of the elastomers of the sealant. It provides 4 wt % of the sealant (exclusive of any PTFE or BN and peroxide) or about 7 wt % of the total elastomer. In other embodiments the polybutadiene may be provided in the range of 5 wt % to about 20 wt % of the total elastomer portion of the sealant, more narrowly from 5 wt % to 15 wt %, or even more narrowly from 5 wt % to 10 wt %. Alternatively worded, in some embodiments the polybutadiene can be provided in the range of about 2.7 wt % to about 14.2 wt % of the EPDM+ components of the sealant (exclusive of the catalyst), more narrowly from 2.7 wt % to 9.9 wt %, or even more narrowly from 2.7 wt % to 6.1 wt %.

In the present examples, carbon black (e.g., N990 carbon black) is provided as small fraction of the overall sealant but in other embodiments, it may provide up to 30 wt percent of the sealant and can provide a similar function to that of the silica-based material and/or it can be used as a colorant. In still other embodiments it may be optional. In alternative embodiments other carbon black materials may be used.

The silica-based material may be an untreated silica, a surface treated silica, a silane treated silica, an organo-functional group treated silica, and/or an aluminosilicate material. It is a high performance reinforcing material that is provided as ultrafine particles. The particles preferably have an average size in the range of 500 to 1000 nm, more narrowly in the range of 600 to 900 nm, and even more narrowly in the range of 750 to 800 nm. In the present examples (See Ex 1 in Table 1), the silica-based material is provided at 38 wt %. In other embodiments, the silica based material and the carbon black combination may provide as little as 0 wt % of the sealant mass to as much as 40 wt %, or in some embodiments in the range of 30 wt % to 40 wt %, or even more narrowly in the range of 35 wt % to 40 wt % in other embodiments. When mixing components during formation of the sealant material, the silicate may be provided in two or more portions so that mixing may be performed at two or more different stages.

Zinc 2-mercaptotoluimidazole is a non-discoloring and non-staining antioxidant and provides 1.5 wt % of the EPDM+ components for the specific embodiments set forth herein but may be provided in an amount as low as 0.5 wt % to as high as 3.0 wt % in other embodiments.

The iron oxide or ferric oxide component (Fe₂O₃) provides a small wt % of the formulation (i.e. 0.4 wt %) in the specific example embodiments set forth herein and provides good light & weather resistant, good dispersion (i.e., homogenous distribution of all particles), high tinting strength (i.e., ability to strongly influence color or the mixture) with bright luster. In other embodiments, the iron oxide may be provided in a quantity has high as 3.0 wt % or as low as 0 wt %.

The zinc oxide (ZnO) component is supplied at 2.5 wt % in the specific examples set forth herein but may be provided in a quantity as high as 5 wt % or little as 1.5 wt % in other embodiments.

The red lead tetra oxide component is provided as a cross-linking agent at 2.3 wt % but may be provided in other quantities such as in the range of 1.0 wt % to about 3.0 wt %.

PTFE, polytetrafluoroethylene, may be provided as a fine powder (e.g. Teflon™ PTFE Fine Powder) at up to 30 phr. The fine powder particles may have a size, for example, in the range of 0.1 to 5 microns or even more narrowly in the range of 1-5 microns. It provides excellent thermal stability to the sealant (i.e. maintenance of chemical structure, mechanical properties, and performance). The PTFE may also provide the sealant with high stress crack resistance (i.e., ability to resist initiation and propagation of cracks), and excellent color and clarity, superior flex life (e.g., up to 10years or more), and low permeability (i.e., diffusion and transmission of hydrogen gas through the cured sealant of less than 3.3×10⁻⁹ m²/s, more preferably less than 3.5×10⁻¹⁰ m²/s, and most preferably less than 2.7×10⁻¹⁰ m²/s).

BN or boron nitride may be provided as a fine powder (e.g. with a particle size in the range of 0.1 microns to 5 microns) and is a heat and chemical resistant crystalline compound with refractory properties composed of boron and nitride. It provides heat and chemical resistance to acids, alkalis, and solvents at room temperature. It resists oxidation up to ˜850° C. in air and to even higher temperatures in inert environments. It can enhance thermal conductivity and provide lubricity that can be maintained at high-temperature and in vacuum environments. The total amount of PTFE and/or BN may be in the range of 0-30 phr. In some embodiments the total may be between 5-20 phr while in others it may be 5-10 phr. In some embodiments, neither BN nor PTFE may be used, in other embodiments one or the other may be used and in still other embodiments both PTFE and BN may be used wherein the total amount of the combination is up to 30 phr, in others it may be capped at 20 phr or less, in still others it may capped at 10 phr or less, while in still further embodiments it may be capped at 5 phr or less. In some embodiments that amount of PTFE and/or BN may be at least 5 phr while in others it may be at least 10 phr.

The peroxide component is provided as a cross-linking agent at 2.3 wt % of the total formulation to be cured but may be provided in other quantities such as from 2.0 wt % to 3.5 wt %. The peroxide is added to the formation after all other formulation ingredients have been mixed (e.g., mixed in separately using two-roll milling) so as to avoid crosslinking during mixing.

### Mixing and Curing—Sample Steps

Step 1: Mix the EPDM components (Parts A, B, and C) and the polybutadiene for at least 90 seconds.

Step 2: Mix the carbon black in the mixture of Step 1.

Step 3: With or without delay, mix the zinc-2 mercaptotolumidazole into the mixture of Step 2 for at least 20 seconds.

Step 4: Mix the iron oxide into the mixture of Step 3 for at least 20 seconds.

Step 5: Mix a first part of the silica based material (e.g., 50%) into the mixture of claim 4 for at least 60 seconds.

Step 6: Mix the zinc oxide into the mixture of Step 5 for at least 20 seconds.

Step 7: Mix a second part of the silica based material (e.g., 50%) into the mixture of Step 6 until the temperature is in a range of about 70-75° C. (e.g., this may take 3-5 minutes).

Step 8: With or without delay, mix the red lead tetra oxide into the mixture of Step 7 for at least 20 seconds.

Step 9: If either, or both, of the PTFE or the BN will be included in the sealant, mix this/these components into the mixture of Step 8 for at least 30 seconds. Hold mixture until ready to cure.

Step 10: When ready to cure, mix peroxide with the mixture of Step 8 or Step 9 as appropriate. The mixing in of the peroxide may occur via a two roll milling process) After mixing in the peroxide, the uncured but initiated mixture may be placed in a mold and heated (e.g., to approximately and 160° C.) and held at the elevated temperature for a set period of time for curing (e.g., approximately two hours).

Numerous alternatives to the formulations and process for mixing are possible. In some embodiments, the mixing of Step 1 to Step 9 may occur using a lab scale Banbury mixer for small quantities or a larger Banbury mixer for industrial scale processing, Some embodiments may use alternative components as noted herein while other alternative components will be apparent to those of skill in the art in review of the teachings herein and thus may be substituted for, or complement, the components noted above. Variations in component quantities are possible with some being identified herein and with others being apparent to those of skill in the art upon review of these teachings. In some embodiments, some components may be eliminated. In some alternative embodiments, the order of mixing may be varied. For example the red lead oxide may be added to the mixture in an earlier step of the process or in a later step. As another example, when both PTFE and BN are to be used (illustrated as part of Step 9), they may be premixed and held until Step is reached, they may be mixed in simultaneously as part of Step 9, or they may be mixed in one after the other as part of Step 9. In some variations the mixing times may be increased or decreased depending on volumes being mixed and the effectiveness of the mixing. In some variations the various components may be split into two or more portions with the different portions mixed in at different times (e.g., similar to that illustrated above for the silica-based material). In still other variations, some components may be premixed and then added to other premixed components.

The five EPDM based formulation embodiments of FIG. 1 have been processed and tested under high hydrogen gas pressure of 90 MPa and during and after a decompression at a rate of 15 MPa/min). These five formations provide different combinations and/or relative amounts of various functional fillers and additives, such as optional thermally conductive, hydrogen barrier, and reinforcing fillers, as well as liquid rubber, antioxidant, and optional abrasion resistant additives. All the formulations were peroxide cured and showed a very low equilibrium hydrogen concentration, as low as 2.2 wt ppm/mm³ compared to higher values for other prior art tested EPDM sealants which are herein referred to as EPDM-1, EPDM-2, and EPDM-3.

The prior art, comparison EPDM formulations (EPDM-1 to EPDM-3) included a single EPDM material (ESPRENE 505) with some including both carbon black and silica additives at a total of 36 to 46 parts per hundred. They prior art formulations also used different additives, such as stearic acid and disulfide. These formulations are the same or similar to some of the formulations set forth in two published papers which are each incorporated herein by reference:
(I) “In situ friction and wear behavior of rubber materials incorporating various fillers and/or a plasticizer in high-pressure hydrogen”, by Wenbin Kuang et al., and published in Tribology International 153 (2021) 106627, published by Elsevier Ltd, and made available online on Sep. 11, 2020 (https://www.sciencedirect.com/journal/tribology-international/vol/153/suppl/C); and
(II) “Multi-scale imaging of high-pressure hydrogen induced damage in EPDM rubber using X-ray microcomputed tomography, helium-ion microscopy and transmission electron microscopy”, by Wenbin Kuang et al., and published in the International Journal of Hydrogen Energy 48 (2023), published by Elsevier Ltd, pages 8573-8587, and made available online on Dec. 17, 2022 (https://www.sciencedirect.com/science/article/pii/S0360319922057184?via % 3Dihub).

The five sealant embodiments explicitly set forth herein are set forth in FIG. 1 and are herein are referred to as: (1) Ex 1 or EPDM+, (2) Ex 2, EPDM+ with 5% PTFE, or simply 5% PTFE; (3) Ex 3, EPDM+ with 10% PTFE, or simply 10% PTFE; (4) Ex 4, EPDM+ with 5% BN, or simply 5% BN; and (5) Ex 5, EPDM+ with 10% BN, or simply 10% BN).

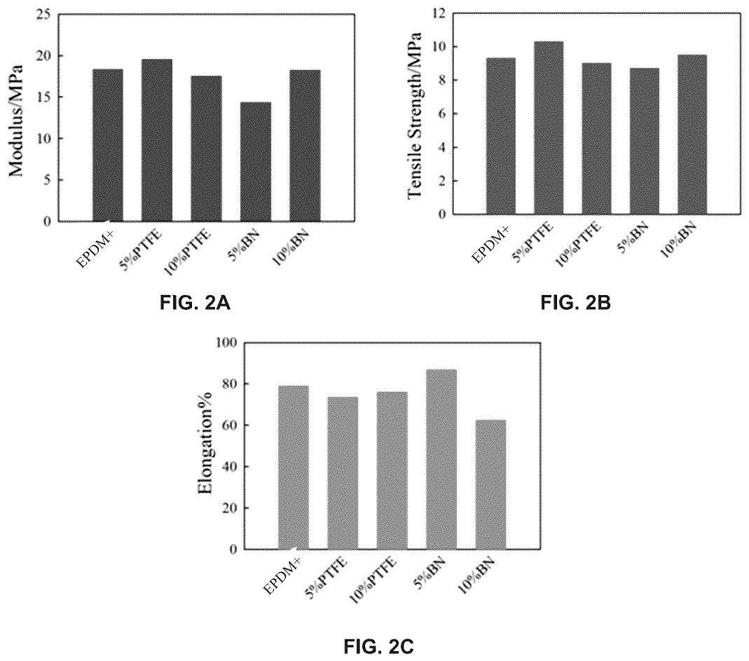

FIG. 2A-2B respectively provide plots of modulus data, tensile strength data and elongation data for each of the five embodiments of FIG. 1. As can be seen, there are no dramatic changes in the mechanical properties of the EPDM+ formula by adding boron nitride (BN) or polytetrafluoroethylene (PTFE) fillers. There is a slight increase in the modulus and tensile strength along with a minor decrease in elongation by adding 5 wt. % PTFE. A decrease in the modulus and a considerable increase in the elongation with a slight decrease in the tensile strength occurs by adding 5 wt. % BN. Similarly there are minimal changes in the mechanical properties of EPDM+ with 10 wt. % PTFE, and minimal changes with EPDM+ with 10 wt. % BN with the exception of a relatively large decrease in elongation.

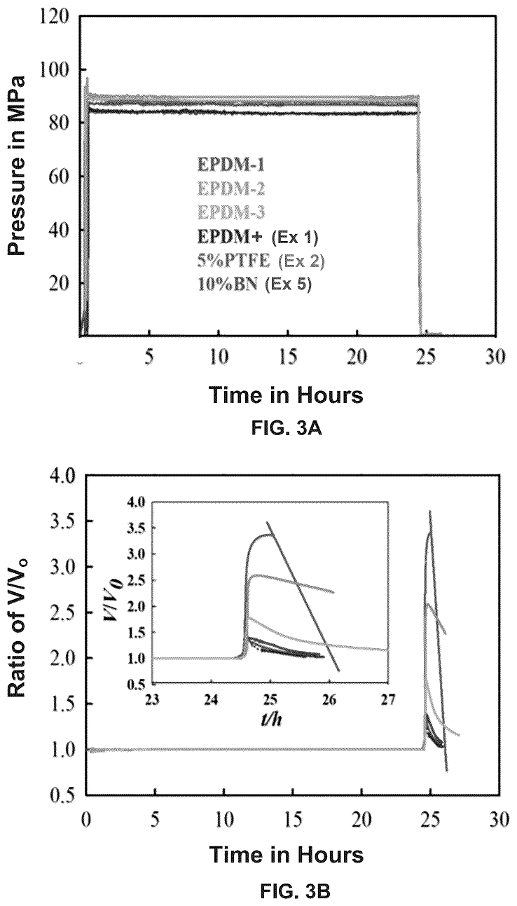

To perform some tests, the five sealants of FIG. 1 and three comparison sealants were hydrogen pressurized at between 85-90 MPa for 24 hours. After that, the pressure was decreased rapidly at a decompression rate of 15.0 MPa/min. The volumes of the samples were recorded as a function of time and pressure. The volume change was used to calculate the swelling % as a result of the decompression process. FIG. 3A provides a plot providing a pressure (in MPa) versus time (in hours) showing high pressure for 24 hours for three comparison samples and for three of the sealants of FIG. 1 followed by a rapid pressure drop off at 24 hours while FIG. 3B provides a plot of current sample volume (V) to an initial or pressured sample volume (V₀) for each sample with a large plot showing the full time period and an inlaid plot showing a time range from 23 to 27 hours so that variations over this particular time range can be more readily seen.

The swelling percentage for EPDM+ was about 41%, while the swelling percentage for EPDM+ with 5 and 10 wt. % of PTFE and BN, respectively, was approximately 37% as can be seen in seen in FIG. 3B. The swelling percentage for comparison formulations (EPDM-1 and EPDM-2) with no fillers was about 250% and 160%, respectively, while that for EPDM-3 (a more typical EPDM with fillers) was about 80% as can also be seen in FIG. 3B. Each of the sealants of FIG. 1 has much lower swelling when compared to EPDM-1 to EPDM-3 under identical conditions.

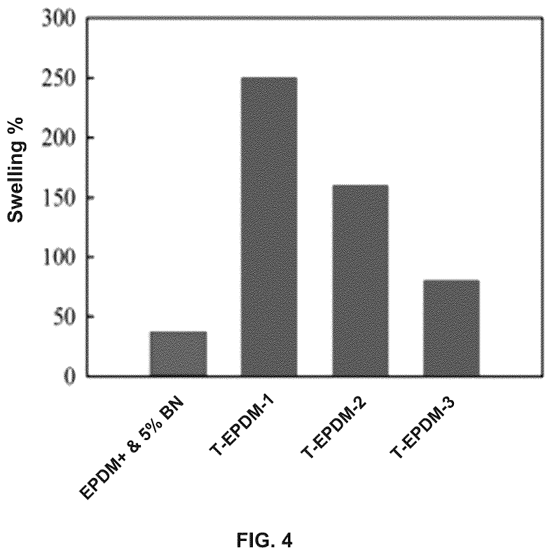

FIG. 4 provides a bar chart showing the significant reduction in swelling between the sealants of FIG. 1, as exemplified by Ex 4 and those of EPDM-1 to EPDM-3.

Thermal desorption analysis (TDA) is a common technique used to determine the equilibrium hydrogen concentration, diffusion coefficient, and hydrogen permeability. All five FIG. 1 EPDM formulations were pressurized at high hydrogen pressure of 90 MPa for 24 hours at room temperature and then the remaining hydrogen content was evaluated immediately after decompression (15 MPa/min). The exponential decay of the hydrogen content with time was fitted to Fick's gas diffusion equation. The continuous red lines passing through the experimental data points are the fitted lines calculated from Fick's gas diffusion equation,

$${C}_{H} ( t ) = \frac{32}{{π}^{2}} \times {C}_{H} ( 0 ) \times [ {\sum }_{n = 0}^{∞} \frac{exp [ {( - 2 n + 1 )}^{2} {π}^{2} Dt / {l}^{2}}{{( 2 n + 1 )}^{2}} ] [ {\sum }_{n = 0}^{∞} \frac{exp [ D {β}_{n}^{2} t / {ρ}^{2} ]}{{β}_{n}^{2}} ] \qquad Eq ( 1 )$$

Where C_{H}(t) is the residual hydrogen content,
D is the diffusion coefficient,
l is the thickness of the sample,
ρ is the radius of the sample, and
βₙ is the root of the zero-order Bessel function.

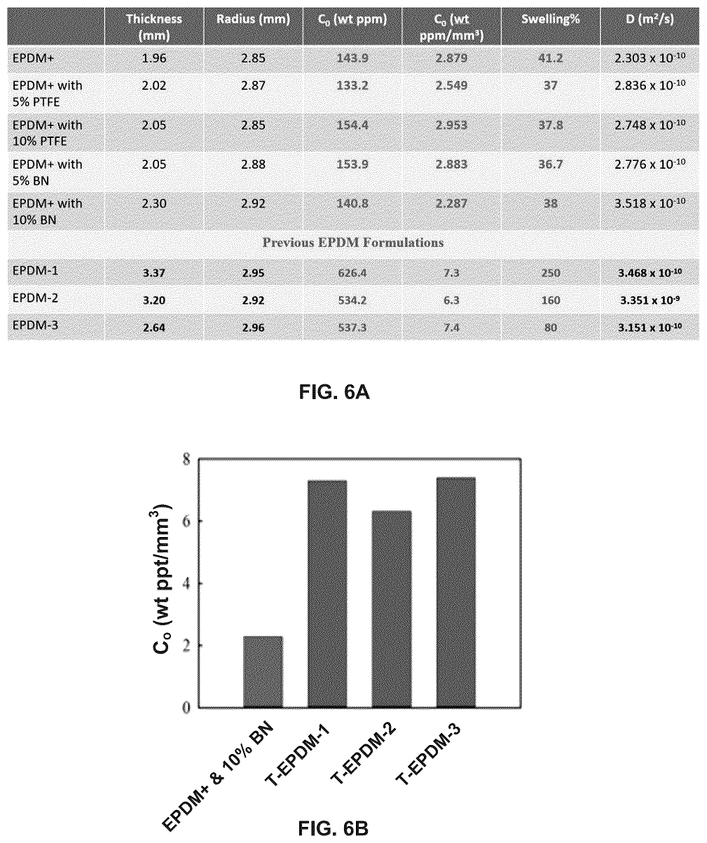

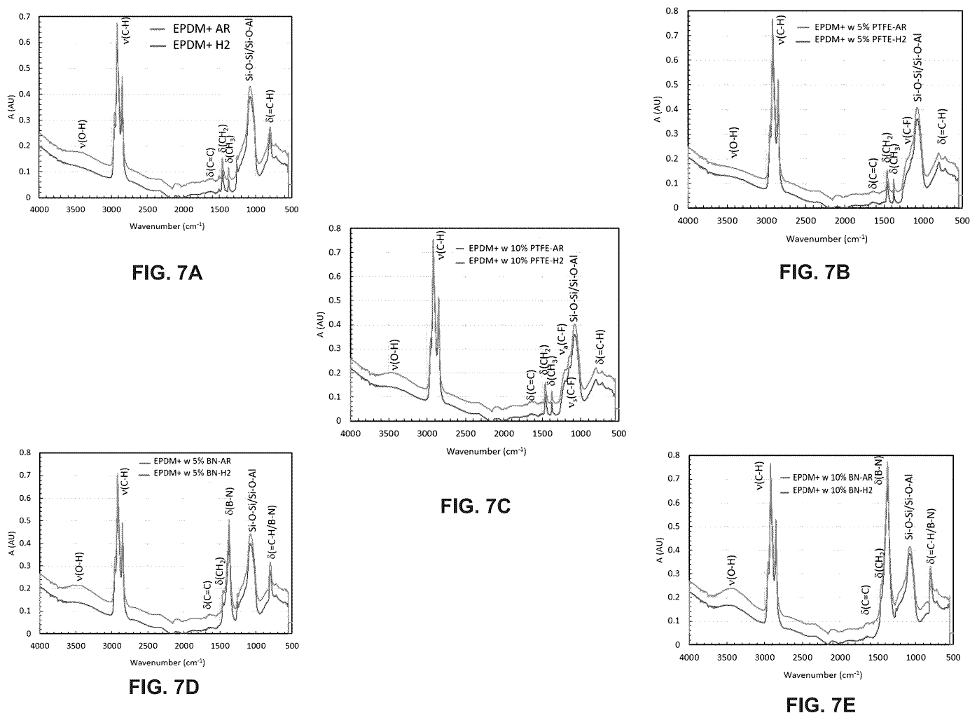

Plots for each of the sealants of FIG. 1 are provided, respectively, in FIGS. 7A-7E. All of sealants of FIG. 1 have extremely low equilibrium hydrogen concentrations (2.2-2.9 wt ppm/mm³) compared to the reference formulations EPDM-1 to EPDM-3 (6.3-7.4 wt ppm/mm³ or more) as can be clearly seen in the data of FIG. 6A and the bar chart of FIG. 6B.

Attenuated Total Reflectance-Fourier Transform Infrared (ATR-FTIR) Spectroscopy is a well-established technique commonly used to evaluate any chemical changes in the materials after high temperature and pressure treatments. The EPDM+ sealant variations of FIG. 1 were investigated by ATR-FTIR before and after treatment with high hydrogen pressure of 90 MPa for 24 hours. Change in the bond strength was determined from the change in the wavenumber (i.e., increase in bond strength indicates a reduction in the wavenumber). As can be seen from the plots of FIGS. 7A-7E, all vibrational peaks including EPDM, the silicate based material, and PTFE were maintained within the resolution limit after hydrogen treatment. As such, no significant changes in the bond strength for all five sealants were seen after hydrogen pressure treatment. Based on this data, it can be concluded that little to no high hydrogen pressure change or degradation in the chemical structure for the sealants occurred.

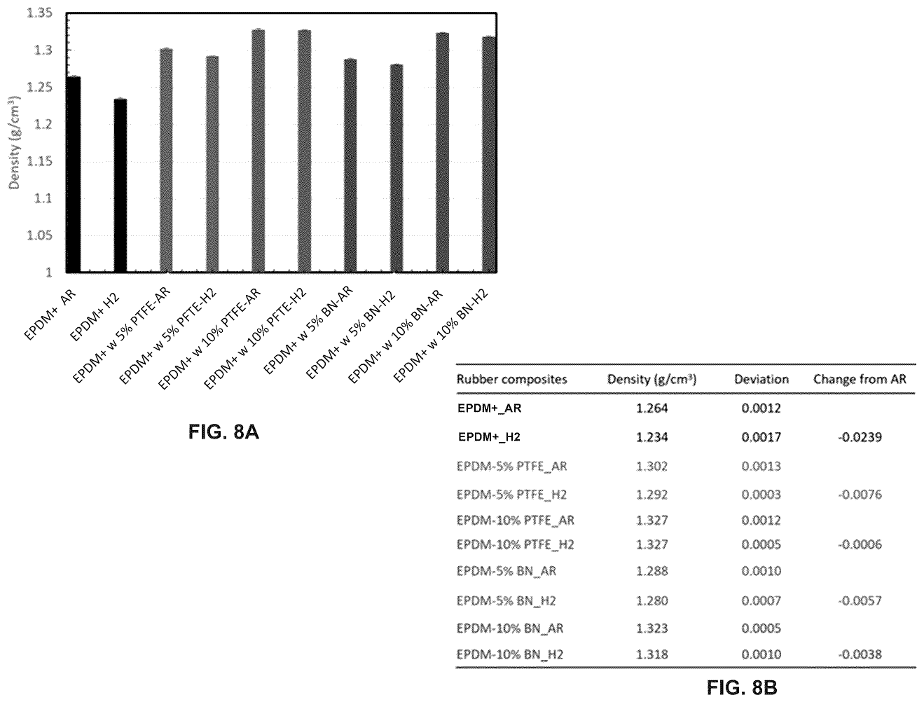

A slight but insignificant decrease in the density of the EPDM+sealant (Ex 1) after high hydrogen pressure treatment at 90 MPa for 24 hours can be seen in the bar charts of FIG. 8A and in the data for FIG. 8B. Similarly, no significant change in the density of all other formulations with PTFE and BN are seen after a 24 hour exposure to high hydrogen gas pressure was seen. As used herein, a density change of no more than 0.1 g/cm³ is considered insignificant. This experimental fact suggests that high hydrogen pressure causes no significant degradation on the sealants of FIG. 1, i.e., no change in density greater than 0.1 g/cm³, no decrease in T_{g} of more than 1.1° C., and no more than a 20% decrease in storage modulus.

Viscoelastic properties of the five example sealants are summarized next. These properties include elastic and viscous moduli, crosslink density, dynamic viscosity, and zero shear viscosity as a function of angular frequency for the fully cured EPDM formulations.

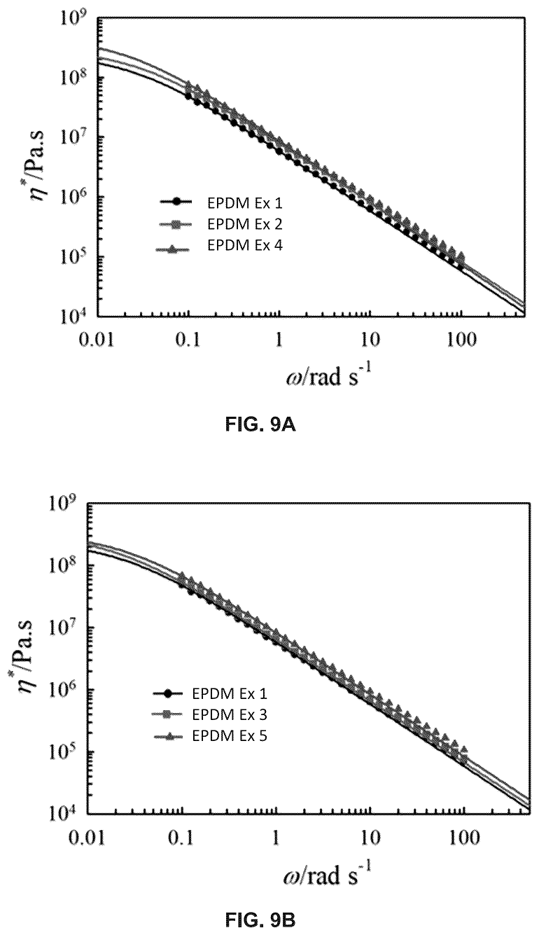

The frequency dependence of the dynamic viscosity of the fully cured EPDM elastomers are demonstrated in FIGS. 9A-9B. FIG. 9A shows the dynamic viscosity as a function of angular frequency of Ex 1, Ex 2, and Ex 4 at 45° C., while FIG. 9B shows the results from the similar measurements for Ex 1, Ex 3, and Ex 5 at 45° C. As noted above, these sealants have different filler contents. The dynamic viscosity increases slightly with increasing the filler content due to the reinforcement effect. The dynamic viscosity of the five different formulations showed non-Newtonian behavior over the entire range of angular frequency (i.e., viscosity strongly depends on angular frequency). The frequency dependence of the dynamic viscosity [η*] can be expressed through the Cross mode by the following equation:

$$[ {η}^{*} ] = \frac{{η}_{0}}{1 + {( \frac{ω}{{ω}_{c}} )}^{β}} \qquad Eq . 2$$

where η₀ is the zero-shear viscosity, ω_{c} is the critical shear frequency value at which the viscosity decreases to half its initial value, and b is a material constant that depends on the nature of the elastomer. Equation 2 was used to calculate η₀ as a fitting parameter to the experimental results using nonlinear regression analysis.

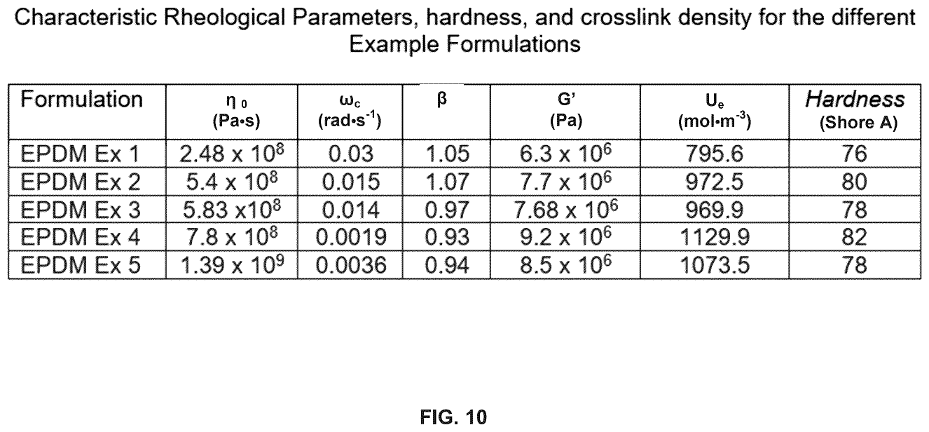

An excellent fit of the data was obtained as shown in FIGS. 9A and 9B. The table of FIG. 10 shows the fitting parameters that were obtained from the regressions. Here the lines in FIG. 9A and 9B are computed from Eq. 2 using the parameters listed in the Table of FIG. 10, while the points show the experimental data. The fully cured elastomer has very high no of 2.48×10⁸ Pa·s for Ex 1. This value increased dramatically to up to 1.39×10⁹ for Ex 5 due to the high filler content. The very high η₀ for all five elastomers at 45° C. indicates that the elastomers will not easily deform. Even at very high angular frequency all the elastomers showed dynamic viscosity above 5×10⁴ pascal seconds, which is still very high and eliminates any significant deformation under high pressure. It is also clear that the hardness of the elastomers increased from 76 for Ex 1 up to 82 for Ex 4 due to the increase of the filler content (see the table of FIG. 10). In the illustrated embodiments, Shore hardness A ranges from 76-82, while in other embodiments hardness may be held between 75 and 80 inclusive. In still other embodiments, hardness may be held in the range from 75-85 inclusive, more generally in the range of 70-90 inclusive, or even more generally in the range of 60-90 inclusive.

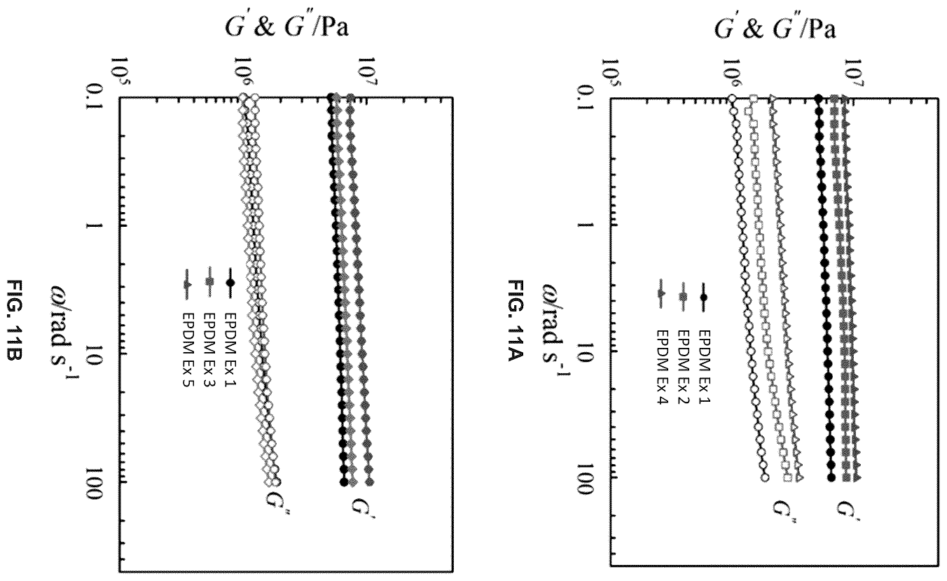

FIG. 11A and 11B provide plots of elastic (G′) and viscous (G″) moduli vs angular frequency for the five different sealant examples (Ex 1 to Ex 5) at 45° C. Clearly, the G′is much higher than G″over the entire range of angular frequency indicating that all the formulations are thermosetting elastomers. It is also clear that both G′ and G″ change slightly with increasing angular frequency due to the formation of equilibrium network structures for all EPDM formulations. These measurements indicate that the sealants are fully cured (plateau of G′and G″). The indicated viscoelastic behaviors can provide for efficient seals for high hydrogen pressure applications. The cross-link density can be evaluated from the plateaus of G′ of each formulation according to the rubber elasticity theory, as described in the following equation:

$${G}^{′} = 3 {υ}_{e} RT \qquad Eq ( 3 )$$

where vₑ is the crosslink density, G′ is the elastic modulus at 45° C., R is the universal gas constant, and T is the absolute temperature. The high values of vₑ for the five elastomers in the Table of FIG. 10 are indicative of low deformation and degradation under high hydrogen pressure which are two useful parameters in designing efficient elastomeric sealants.

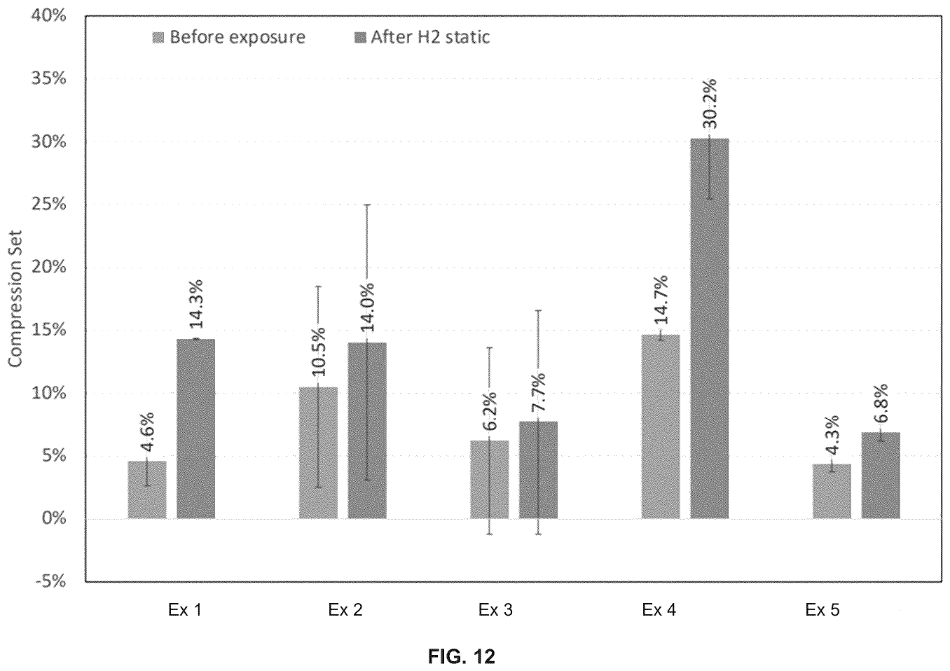

Compression set testing (CST) was conducted following ASTM D395, Test Method B: Compression Set under Constant Deflection in Air. Duplicate specimens were cut from each material, 6 mm×20 mm, and the starting thickness of each specimen was measured on a LaserMike 183 laser micrometer before being placed on the bottom plate of the compression setup. A constant deflection of 25% was applied to each specimen when compressed between two stainless steel plates, the deflection was defined by a spacer bar chosen to be 75% of the original specimen thickness. The entire compression jig was placed in a 110° C. oven for 22 hours, after which the specimens were removed from the jig and allowed to recover for 30 minutes at room temperature. The specimen thickness was then measured with the laser micrometer and compression set calculated as a percentage of the original deflection using the equation below:

$${C}_{B} = ⌈ \frac{( {t}_{0} - {t}_{1} )}{( {t}_{0} - {t}_{n} )} ⌉ \times 100 \% \qquad Eq ( 4 )$$

where C_{B} stands for compression set in percentage, t₀ for original thickness of the specimen, t₁ for final thickness of the specimen, and tₙ for thickness of the spacer bar. The compression set values were measured for each sealant material, taken before (i.e., the left measurement of each set) and after hydrogen exposure (i.e., the right measurement of each set) where separate sample specimens were used for each measurement with each sample specimen being measured multiple times to provide standard deviations with the results and standard deviation bars shown in FIG. 12.

Most of the new formulations showed very low compression set compared to other formulations in literature. In addition, Ex 2, Ex 3, and Ex 5 have very low changes in the compression set after exposure to high pressure hydrogen gas.

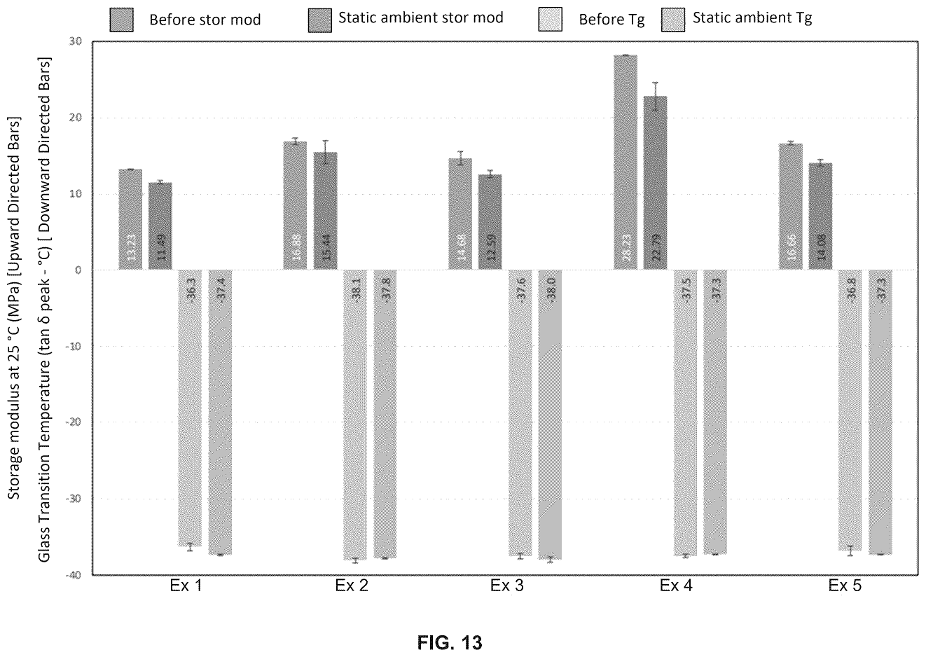

For DMA measurements, the value of the storage modulus (E′) and tan δ (T_{g}) for the five example sealants (Ex 1 to Ex 5) before and after exposure to high hydrogen pressure have no significant change as can be seen in FIG. 13 where, as with FIG. 12, bars and data from measurements prior to hydrogen pressurization are shown on the left for each measurement set while bars and data for post hydrogen pressurization measurements are shown to the right for each data set and wherein upward pointing bars show modulus measurement results and downward pointing bars show glass transition temperature results T_{g}. This data indicates that the new EPDM formulations have very good hydrogen compatibility.

### Additional Remarks

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any variations of the aspects (as well as variations in any embodiments) set forth herein represent individual and separate features may be individually added to independent claims, added as dependent claims to further define an invention to be claimed, or in some cases may even be the basis for separate independent claims.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A sealant for high pressure hydrogen gas storage, comprising:
(a) 40 to 60 wt % elastomer as a combination of an ethylene propylene diene monomer (EPDM) mixture and polybutadiene wherein the EPDM mixture, comprises:
(I) a first EPDM component (EPDM-A) comprising an EPDM material having a vinyl norbornene diene content in the range of 1%-7% of the first EPDM component and a high ethylene/propylene weight ratio in the range of 60:40 to 51:49 which forms a crystalline terpolymer having a Mooney viscosity in a range of 30 to 60 Mooney units, and a specific gravity within the range of 0.8 to 1.1 g/cm³;
(II) a second EPDM-like component (EPDM-B) comprising an ethylene-propylene liquid copolymer having an ethylene/propylene ratio in the range of 35:65 to 47:53, a density in the range of 0.8-1.1 g/cm³, a molecular weight in the range of 15,000 to 60,000 g/mol, and a viscosity at 100° C. in the range of 30,000 to 155,000 cP wherein the second EPDM component provides an intermediate quantity of the EPDM mixture which is less than the portion of the EPDM mixture provided by the first EPDM component; and
(III) a third EPDM component (EPDM-C) comprising a low-molecular weight EPDM terpolymer having a diene content in the range of 5% to 12 wt % of the third EPDM component, and an ethylene/propylene ratio in the range of 40:60 to 53:47, a density in the range of 0.8-1.1 g/cm³, a molecular weight in the range of 30,000 to 100,000 g/mol, and a viscosity at 100° C. in the range of 100,000 to 210,000 cP, wherein the third EPDM component provides the smaller quantity of the EPDM mixture than either the first component or the second component;
(b) an ultrafine particle reinforcement material providing 0 to 40 wt % of the sealant exclusive of any BN or PTFE wherein the ultrafine material comprises a material selected from the group consisting of (I) carbon black, (II) a silica-based material; and (III) a combination of (b)(I) and (b)(II);
(c) 0.5 to 3.0 wt % zinc 2-mercaptotolumidazole;
(d) 0.1 to 3.0 wt % iron oxide (Fe₂O₃);
(e) 0 to 5 wt % zinc oxide (ZnO);
(f) 1.0-3.0 wt % red lead tetra oxide;
(g) 0-30 phr powdered polytetrafluoroethylene (PTFE);
(h) 0-30 phr powdered boron nitride (BN); and
(i) 1.5-3.5 wt % of a curing agent comprising a material selected from the group consisting of: (I) peroxide, (II) sulfur; (III) a combination of (i)(I) and (i)(II),
wherein the weight percentages of components of (a) to (f) are based on the total of the weight of components (a) to (f) unless otherwise specifically indicated, the phr of components (g) and (h) are based on total weight of components (a) to (f), and the weight percentage of the curing agent is based on the total weight of components (a)-(h), and
wherein the sealant is comprised of components (a)-(i) cured together.

2. The sealant of claim 1 wherein the first EPDM component provides 50 to 75 wt % of the EPDM mixture; the second EPDM component provides 10 to 30 wt % of the EPDM mixture; and the third EPDM component provides 5 to 20 wt % of the EPMD mixture.

3. The sealant of claim 2 wherein the first EPDM component provides 70-71 wt % of the EPDM mixture; the second EPDM component provides 20-21 wt % of the EPDM mixture; and the third EPDM component provides 8-10 wt % of the EPDM mixture.

4. The sealant of claim 1 wherein the EPDM mixture provides 80 to 95 wt % of the elastomer.

5. The sealant of claim 1 wherein the polybutadiene provides 5 to 20 wt % of the elastomer components.

6. The sealant of claim 1, wherein the formulation comprises (b)(II) and wherein the silica-based mineral of (b)(II) is selected from the group consisting of: (A) an aluminosilicate material, and (B) a surface treated silica.

7. The sealant of claim 6 wherein the silica-based material comprises up to 39.9 wt % of the sealant.

8. The sealant of claim 1 wherein the carbon black provides 0.1 to 30 wt % of the sealant.

9. The sealant of claim 1 wherein the curing agent comprises a cross-linking agent.

10. The sealant of claim 1 wherein the cross-linking agent comprises a peroxide.

11. The sealant of claim 1 wherein the sealant comprises PTFE but not boron nitride.

12. The sealant of claim 11 wherein the sealant comprises 4 to 15 phr PTFE.

13. The sealant of claim 1 wherein the sealant comprises boron nitride but not PTFE.

14. The sealant of claim 13 wherein sealant comprises 4 to 15 phr of boron nitride.

15. The sealant of claim 1 wherein the sealant swells less than 200% when subjected to a pressure reduction from 90 MPa to 1 ATM in 6 minutes or less.

16. The sealant of claim 15 wherein the sealant swells less than 100% when subjected to a pressure reduction from 90 MPa to 1 ATM in 6 minutes or less.

17. The sealant of claim 16 wherein the sealant swells less than 50% when subjected to a pressure reduction from 90 MPa to 1 ATM in 6 minutes or less.

18. The sealant of claim 1 wherein sealant comprises at least one property selected from the group consisting of:
(1) the polybutadiene providing 6-8 wt % of the elastomer components;
(2) the ultrafine particle reinforcement material comprises a combination of (b)(I) and (b)(II) of claim 1;
(3) the iron oxide providing 0.1-2.0 wt % of the sealant;
(4) the zinc oxide providing 1-5 wt % of the sealant;
(5) the sealant comprising 8-12 phr PTFE;
(6) the sealant comprises 8-12 phr boron nitride; and
(7) the sealant comprises both PTFE and boron nitride.

19. A sealant formulation useful for high pressure hydrogen gas storage applications when cured, comprising:
(a) 40 to 60 wt % elastomer as a combination of an ethylene propylene diene monomer (EPDM) mixture and polybutadiene wherein the EPDM mixture, comprises:
(I) a first EPDM component (EPDM-A) comprising an EPDM material having a vinyl norbornene diene content in the range of 1%-7 wt % of the first EPDM component and a high ethylene/propylene weight ratio in the range of 60:40 to 51:49 which forms a crystalline terpolymer having a Mooney viscosity within a range of 30 to 60 Mooney units, and a specific gravity within the range of 0. 8 to 1.1 g/cm³;
(II) a second EPDM-like component comprising an ethylene-propylene liquid copolymer having an ethylene/propylene ratio in the range of 35:65 to 47:53, a density in the range of 0.8-1.1 g/cm³, a molecular weight in the range of 15,000 to 60,000 g/mol, and a viscosity at 100° C. within the range of 30,000 to 155,000 cP wherein the second EPDM component provides an intermediate quantity of the EPDM mixture which is less than the portion of the EPDM mixture provided by the first EPDM component; and
(III) a third EPDM component comprises a low-molecular weight EPDM terpolymer having a diene content in the range of 5% to 12 wt % of the third EPDM component, and an ethylene/propylene ratio in the range of 40:60 to 53:47, a density in the range of 0.8-1.1 g/cm³, a molecular weight in the range of 30,000 to 100,000 g/mol, and a viscosity at 100° C. within the range of 100,000 to 210,000 cP, wherein the third EPDM component provides the smaller quantity of the EPDM mixture than either the first component or the second component;
(b) an ultrafine particle reinforcement material providing 0 to 40 wt % of the sealant exclusive of any BN or PTFE wherein the ultrafine material is selected from the group consisting of (I) carbon black, (II) a silica-based material; and (III) a combination of (b)(I) and (b)(II);
(c) 0.5 to 3.0 wt % zinc 2-mercaptotolumidazole;
(d) 0.1 to 3.0 wt % iron oxide (Fe₂O₃);
(e) 0 to 5 wt % zinc oxide (ZnO);
(f) 1.0-3.0 wt % red lead tetra oxide;
(g) 0-30 phr powder polytetrafluoroethylene (PTFE); and
(h) 0-30 phr powdered boron nitride (BN);
wherein the weight percentages of components of (a) to (f) are based on the total weight of components (a) to (f) unless otherwise specifically indicated, and the phr of components (g) and (h) are also based on total weight of components (a) to (f), and
wherein the components are curable to form a sealant material.

20. A sealant formulation useful for high pressure hydrogen gas storage applications, comprising:
(a) 40-60 wt % of an elastomer mixture comprising two different EPDM terpolymer materials having different diene contents and different ethylene/propylene ratios, an ethylene/propylene copolymer, and a polybutadiene material;
(b) 0 to 40 wt % of an ultrafine particle reinforcement material comprises a silica-based material;
(c) 0.5 to 3.0 wt % zinc 2-mercaptotolumidazole;
(d) 0.1 to 3.0 wt % iron oxide (Fe₂O₃);
(e) 0 to 5 wt % zinc oxide (ZnO);
(f) 1.0-3.0 wt % red lead tetra oxide;
(g) 0-30 phr powder polytetrafluoroethylene (PTFE); and
(h) 0-30 phr powdered boron nitride (BN);
wherein the weight percentages of components of (a) to (f) are based on the total of the weight of components (a) to (f) and the phr of components (g) and (h) are also based on total weight of components (a) to (f), and
wherein the components are curable to form a material capable of being used as a hydrogen sealant.
